(19) United States
(12) Patent Application Publication
(10) Pub. No.: US 2005/0161292 A1
(43) Pub. Date: Jul. 28, 2005

(54) Inboard braking trailer wheel end assembly

(76) Inventors: Daniel Chien, Franklin, MI (US); Martin Peaker, Upton (GB); David Chan, Hawarden (GB); Garry Brereton, Rosset (GB); Peter Kerslake Gibbens, Lliswerry (GB); Paul Roberts, Newport (GB); Paul Anthony Thomas, Newport (GB); Jonathan Leslie Christopher Jackson, Ross-On-Wye (GB)

Correspondence Address: CARLSON, GASKEY & OLDS, P.C., 400 WEST MAPLE ROAD, SUITE 350, BIRMINGHAM, MI, 48009, US

(21) Appl. No.: 10/763,714

(22) Filed: Jan. 23, 2004

(51) Int. Cl. B60T 1/06

(52) U.S. Cl. 188/18 A

(57) ABSTRACT

An axle assembly includes a shaft supported for rotation within an axle housing. The housing is mountable to a trailing arm pivotal relative to a vehicle. The axle shaft includes a hub mounted on a first end for mounting of a wheel. A rotor is mounted to a second portion of the axle. The second portion of the axle shaft and rotor is mounted at a position inboard of any portion of the wheel rim. Mounting of the rotor outside any portion of the wheel rim allows the rotor, caliper, and actuator to be configured without constraints on size and cooling concerns inherent with brake assemblies positioned within the circumference of the wheel rim.

### BACKGROUND OF THE INVENTION

This invention generally relates to a trailer wheel assembly and specifically to a trailer wheel assembly including an inboard brake.

Typically, commercial vehicle trailer axles comprise an axle hung from a trailing arm on either side of the trailer chassis and supported by a suspension member such as a leaf spring or air spring assembly. The axle is attached to the suspension member by U bolts or spring seats as is known to a worker skilled in the art. A brake assembly is mounted to each wheel inside an inner circumference of the wheel. The brake assembly is mounted such that the wheel hub rotates around the brake assembly disposed within the inner circumference of the wheel rim. The brake assembly typically includes a rotor attached to a hub fixed to the end of the rotating axle. The hub and rotor are attached such that brake torque generated at the rotor is transmitted to the hub and in turn to the road wheel.

The inner circumference of the wheel rim is a constraint on the configuration of the brake assembly. The inner circumference of the standard sized road wheel common to commercial cargo trailers constrains the overall configuration of the brake disposed within the wheel rim. The installation angle of the brake is restricted by the need to clear the axle along with fitting within the inner circumference of the wheel rim. A further limitation on the brake assembly is the need for replacement of worn brake components such as brake pads or the brake rotor. Replacement of worn brake pads or brake rotors requires removal of the road wheel from the vehicle. Further, the overall size of the rotor must fit within the wheel rim inner circumference. As appreciated, limits on the configuration of the brake assembly translate into limitations on the overall braking capacity of the brake assembly. In addition to overall configuration constraints, the installation of the brake assembly within the wheel rim limits the amount of cooling airflow over the rotor and brake pads.

Accordingly, it is desirable to develop a brake assembly free from limitations encountered by mounting the brake assembly within an inner circumference of the wheel rim.

### SUMMARY OF THE INVENTION

This invention is a wheel end assembly including a brake assembly mounted inboard of a wheel rim and hub.

The wheel end assembly includes an axle shaft mounted for rotation within an axle housing. The axle shaft includes a hub mounted to a first end for mounting a wheel. A rotor is fixed to a second end of the axle shaft cooperates with a brake caliper assembly for braking the wheel. The caliper assembly is mounted to the housing and the housing is mounted to a suspension member of the trailer. The rotor is mounted to the axle shaft at a point inboard of any portion of the wheel rim.

Each wheel assembly of the trailer includes an axle shaft including first and second ends. A hub is mounted on the first end to facilitate mounting of the wheel rim. The second end of the shaft includes a rotor that is selectably engagable by a caliper. Each side of the trailer includes a separate wheel assembly and a separate brake assembly. The caliper and rotor of each brake assembly is mounted outside of the wheel assembly and inboard of the wheel rim on the trailer.

In another embodiment of this invention, wheels on each side of the trailer are mounted to a common axle shaft and a single brake assembly is used to stop wheels on the common axle shaft. The axle shaft includes a hub on each end for mounting of a wheel. The brake assembly is mounted on the axle shaft inboard of each wheel hub. A rotor mounted to the axle shaft rotates with the axle shaft and cooperates with a caliper and actuator to brake the entire axle.

Accordingly, this invention provides a wheel end assembly including a brake assembly mounted inboard of the wheel rim removing constraints caused by wheel dimensions.

### BRIEF DESCRIPTION OF THE DRAWINGS

FIG. 1 is a side view of a wheel assembly for a non driven wheel;

FIG. 2 is a top view of the embodiment shown in FIG. 1; and

FIG. 3 is a top schematic of an alternate embodiment of the trailer wheel assembly.

### DETAILED DESCRIPTION OF THE PREFERRED EMBODIMENT

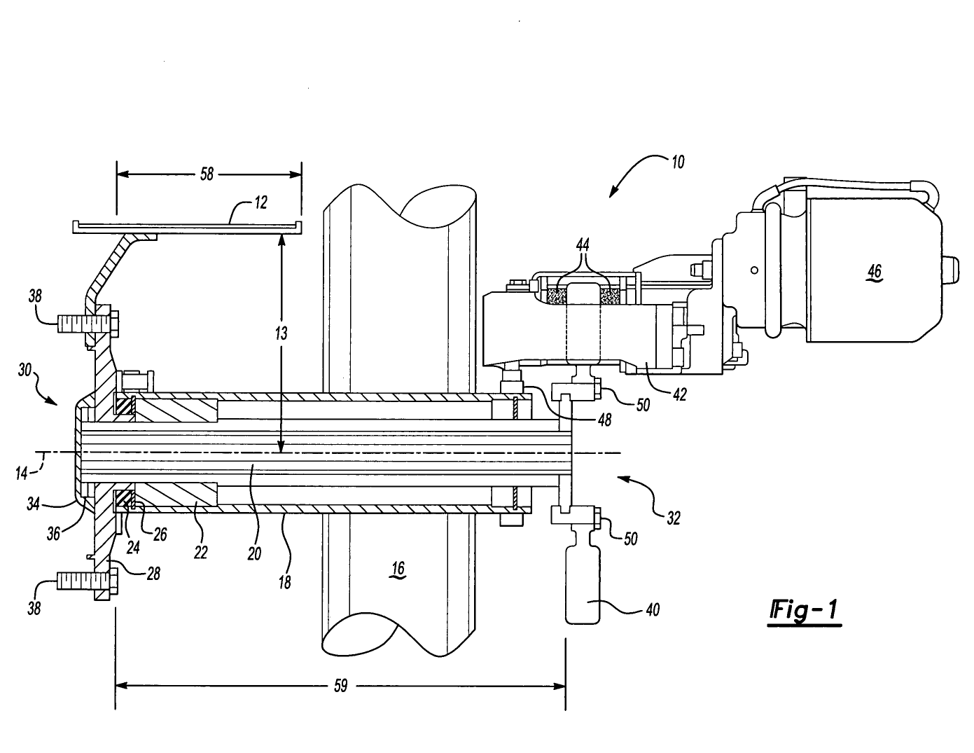

Referring to FIG. 1, a wheel end assembly 10 includes a wheel 12 mounted to a hub 28. The hub 28 is mounted to a first end 30 of an axle shaft 20. The axle shaft 20 is supported for rotation about an axis 14 within an axle housing 18. Bearing assemblies 22 within the axle housing 18 support rotation of the axle shaft 20. Snap rings 26 hold the bearing assemblies 22 within the axle housing 18. Seals 24 outboard of the snap rings 26 hold lubricant within the axle housing 18.

A rotor 40 is mounted to a second end 32 of the axle shaft 20. Threaded members 50 secure the rotor to the axle shaft 20. A caliper 42 includes brake pads 44 that are selectively engagable to the rotor 40 in response to actuation of actuator 46. The caliper 42 engages the rotor 40 to slow of stop the axle shaft 20. The caliper 42 is actuated by a pneumatic actuator 46. Although a pneumatic actuator 46 is shown in this embodiment, it is in the contemplation of this invention that any type of a brake actuator known to a worker skilled in the art can be used.

The brake rotor 40, caliper 42, and actuator 46 are disposed inboard of the wheel 12. The wheel 12 includes a portion that extends parallel to the axis of rotations 14 a fixed distance 58 from the hub 28. The rotor 40 is mounted on the axle shaft 20 a distance 59 from the hub 28 that is greater than the distance 58. The rotor 40 is disposed inboard of the wheel 12. Because the rotor 40 is disposed outside of an inner circumference 13 of the wheel 2, the rotor 40 can be inspected and maintained without removal of the wheel 12. In addition, the pads 44 can be inspected and removed without removing the wheel 12.

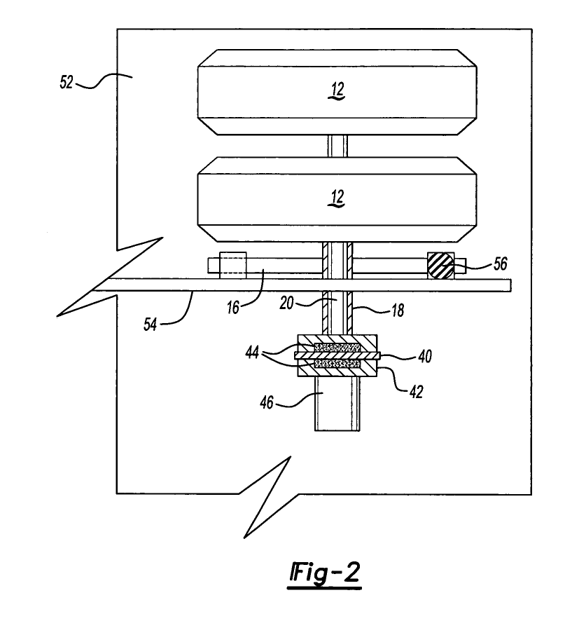

Referring to FIGS. 1 and 2, the vehicle 52 includes a wheel end assembly 10 at opposite sides of the vehicle 52 operating independent of one another. Each axle shaft housing 18 is mounted to a trailing arm 16. The trailing arm 16 is pivotally attached on one end to a frame member 54. On a second end of the trailing arm 16 is a dampening member 56. Movement of the trailing arm 16 in response to inconsistencies in the roadway is controlled by the dampening member 56. In should be understood that it is within the contemplation of this invention to mount the axle housing 18 to the frame 54 in any manner known to a worker skilled in the art.

The rotor 40 and caliper 42 are sized according to application specific requirements without the physical limits present in prior art brake assemblies mounted within the inner circumference 13 of the wheel 12. Further, the specific configuration of the actuator 46 and caliper 42 may be disposed at any position relative to the rotor 40 without regard for possible interference with the hub 28 or wheel 12. In addition, because the rotor 40 is located outside of the inner circumference 13 of the road wheel 12, airflow over the rotor 40 and through the caliper 42 is increased to provide beneficial cooling without restriction caused by confinement within the wheel 12.

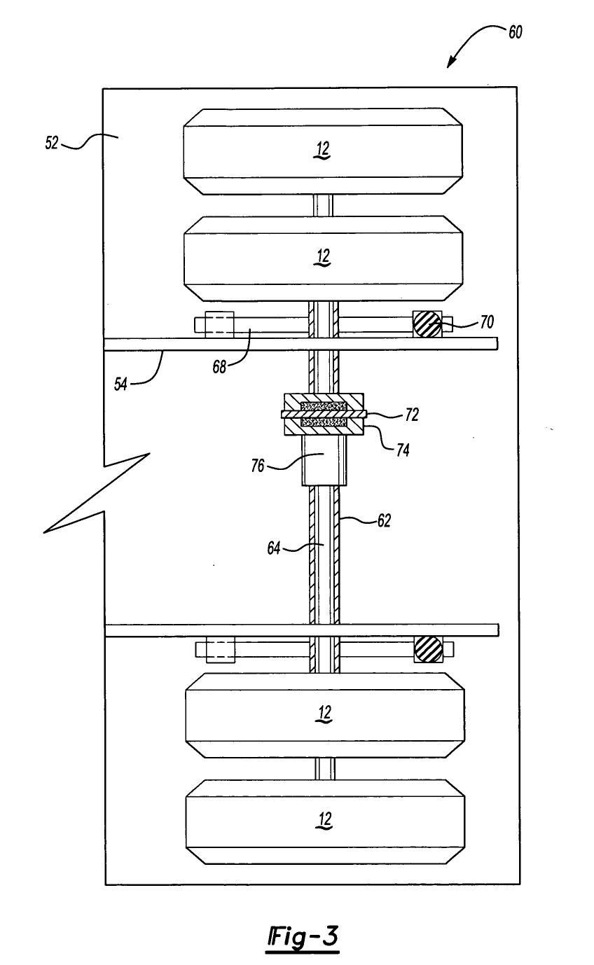

Referring to FIG. 3, another embodiment of this wheel assembly is generally indicated at 60 and mounted to vehicle 52 having an axle shaft 64 that extends along the entire width of the vehicle 52. Wheels 12 are mounted to either side of the axle shaft 64 such that a single axle shaft freely rotates in response to movement of vehicle 52.

In this embodiment, a single rotor 72 is mounted at a point outside of the circumference of the wheels 12. The rotor 72 is mounted at a position inboard of wheels 12 disposed on either side of the axle shaft 64. Actuator 76 actuates the caliper 74 to engage the rotor 72. Because the rotor 72, caliper 74 and actuator 76 are mounted inboard of either wheel assembly, the size and specific configuration are not constrained by the inner circumference of the wheels 12 and can be sized as to provide sufficient braking supports and forces to brake the wheels disposed on either sides of the vehicle 52. Therefore, the brake rotor 72 calipers 74 can be increased in size to provide sufficient braking torque in order to stop wheels 12 disposed on either side of the vehicle 52.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason the following claims should be studied to determine the true scope and content of this invention.

1. An axle assembly for a vehicle comprising:
an axle shaft having a first end and a second end, said axle shaft mounted for rotation within a housing, said first end and said second end extending outside of said housing;
a hub fixed to said first end of said axle shaft; and
a brake assembly including a rotor disposed outside of said housing and attached to said axle shaft adjacent said second end, wherein said second end is spaced apart from said hub a first length greater than an axial length of said housing.

2-3. (canceled)

4. The assembly of claim 1, wherein said brake assembly includes an actuator mounted to said housing for actuating a caliper for selectively engaging said rotor.

5. (canceled)

6. The assembly of claim 4, wherein said actuator is pneumatically operated.

7. The assembly of claim 4, wherein said actuator is hydraulically actuated.

8. The assembly of claim 1, including bearing assemblies disposed within said housing for supporting rotation of said axle shaft relative to said housing.

9-10. (canceled)

11. The assembly of claim 1, wherein said housing is mountable to a suspension arm.

12. The assembly of claim 11, wherein said suspension arm is pivotally mountable to a frame of a motor vehicle.

13. A brake assembly comprising:
an axle shaft supported for rotation within an axle housing, said axle shaft having a first end and a second end;
a hub fixed to said first end of said axle shaft;
a rotor fixed adjacent said second end of said axle shaft outside of said axle housing; and
a first brake pad and a second brake pad supported within a caliper mounted to said axle housing and selectively engagable with said rotor.

14. The assembly of claim 13, further including a brake actuator for moving said first brake pad and said second brake pad into engagement with said rotor.

15. The assembly of claim 13, including bearing assemblies disposed within said axle housing for supporting said axle shaft for rotation relative to said axle housing.

16. (canceled)

17. The assembly of claim 13, including seals disposed between said axle housing and said axle shaft.

18. The assembly of claim 13, wherein said axle housing is mountable to a trailing arm pivotally attachable to a frame member on a first end and supported by a suspension member on a second end.

19. A brake assembly comprising:
a housing having an axial length;
an axle supported for rotation within said housing, said axle having a first end portion and a second end portion both extending outwardly from said housing, said second end portion spaced apart from said first end portion a length greater than said axial length of said housing;
a wheel hub attached to said first end portion of said axle;
a rotatable brake member attached to said second end portion; and
an actuator for selectively moving friction members into engagement with said rotatable brake member.

20. The assembly as recited in claim 19 wherein said rotatable brake member comprises a rotor.

21. The assembly as recited in claim 20 wherein said actuator comprises a caliper for supporting movement of said friction members into engagement with said rotor.

22. The assembly as recited in claim 19 wherein said housing is supported on a trailing arm, said trailing arm pivotally attachable to a vehicle frame member.

23. The assembly as recited in claim 19, wherein said rotatable brake member is accessible without removal of a wheel mounted to said wheel hub.

24. The assembly as recited in claim 19, wherein said axial length of said housing is greater than a length of a vehicle wheel rim measured along an axis of rotation.
